(19) United States
(12) Patent Application Publication
(10) Pub. No.: US 2011/0188278 A1
(43) Pub. Date: Aug. 4, 2011

(54) Electron avalanche drive circuit

(76) Inventor: Gary J. Magratten, Willits, CA (US)

(21) Appl. No.: 12/658,088

(22) Filed: Feb. 1, 2010

(51) Int. Cl. H02M 7/46

(52) U.S. Cl. 363/132

(57) ABSTRACT

Disclosed herein is an electron avalanche drive circuit whereby electron avalanche is produced in a high voltage spark gap exposed to open air or other suitable gaseous medium. The electrochemical process of electron avalanche produces additional current that is delivered to an inductive load.

Also disclosed is an electron avalanche drive circuit that employes a high speed, unidirectional switching circuit. The high speed unidirectional switching circuit allows the additional current developed by electron avalanche in the main circuit to sink to ground.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to power drive electric circuits. The invention specifically relates to a new circuit that employs electron avalanche as developed in a high voltage spark gap exposed to open air. The process of electron avalanche produces an increase in current that is delivered to the load.

2. Prior Art

Electric drive circuits provide power to loads. All electric circuits providing power to loads have losses due to the inefficiency of components.

Many improvements have been made in electronic and electrical components to improve the efficiency of delivering power to the load. A few attempts at employing a high voltage spark gap exposed to open air for the purpose of improving circuit efficiency have been partially developed. A proper understanding of the process of electron avalanche as developed in a high voltage spark gap exposed to open air is essential to this invention.

Electron avalanche and electron multiplication during an electric spark discharge is a well established scientific principle. The major contribution to the establishment of the scientific phenomenon of electron avalanche is the work of L. B. Loeb and J. M. Meek as explained in The Mechanism of the Electric Spark, Stanford University Press, 1941.

A spark discharge developed in a high voltage spark gap exposed to open air results in the multiplication of electrons which are absorbed by the spark gap's anode. This increase in electrons forms additional current delivered to the load.

In order to properly understand the development of increased current in an electric circuit by means of electron avalanche, Chapter 2, The Streamer Theory of Spark Discharge, 1. Anode Space-Charge Field Due to Avalanche is directly quoted,

“One may begin by considering a plane-parallel gap of 1 cm length in which a cathode is illuminated by ultraviolet light to the extent that one electron per microsecond leaves one square centimeter of cathode area. Assume that in air at atmospheric pressure the potential across the plates is 31,600 volts, which is the conventional sparking potential Vₛ.

Let us calculate what happens to one of these electrons. It starts across the gap, quickly acquiring an average random energy of some E=mc²=3.6 electron volts and a drift velocity (v) in the field direction of about 1.5 to 2 times 10⁷ centimeters per second as measured by White and Raether. As it moves it creates new electrons at (a) per centimeter in the field direction so that in a distance (x) it and its progeny amount to (e^{(ax)}) electrons, forming an electron avalanche. Therefore, (e^{(ax)}) positive ions have been left behind by the electron group.

The first ion pair is created at 0.047 cm from the cathode. At 0.5 cm from the cathode there are 4914 ions, at 0.75 cm there are 3.66 times 10⁵ ions, and within 0.0407 cm from the anode there are 1.2 times 10⁷ ions. Most electrons will be drawn into the anode except for some few that are bound by positive ions, making a sort of conducting plasma in the avalanche path.”

Nikola Tesla was issued a U.S. Pat. No. 787,412 on Apr. 18, 1905 entitled Art of Transmitting Electrical Energy Through The Natural Medium. Tesla employed a high voltage spark gap exposed to open air so that the electric current in the secondary system was greatly magnified by the inductive action of the primary.

The apparatus was intended to transmit communications over great distances. The very high voltage necessary for the operation of the device made it impractical.

Edwin V. Gray employed a high voltage spark gap exposed to open air in his U.S. Pat. No. 3,890,548 entitled, Pulsed Capacitor Discharge Electric Engine issued Jun. 17, 1975. The purpose of the spark gap was to provide accurate timing for the discharge of capacitors. At the time, those skilled in the art were unaware that electron avalanche, as developed in a high voltage spark gap exposed to open air, could increase the current to the inductive load. Carefull examination of the placement of the spark gap in the patent drawings show the spark gap after the inductive load rather that before it. This prevented additional current from electron avalanche from being employed to the inductive load.

At present there is no known electric power drive circuit operated on the principle of electron avalanche as developed in a spark gap exposed to open air in order to increase the current delivered to the load. The employment of electron avalanche as developed in a high voltage spark gap exposed to open air for the delivery of additional current to an inductive load is unobvious to all skilled in the art. The result achieved by the employment of the invention for the delivery of increased current to the inductive load is new, unexpected and superior to all prior art.

The prior art referenced were inoperative in that they did not employ electron avalanche in a practical way for the delivery of increased current to the load. The prior art referenced were also inoperative in that they were impossible to succesfully be reconstructed. Another novel mechanism associated with the invention is the use of a high speed, unidirectional switching system to release the additional current developed by electron avalanche from the main circuit.

### OBJECTS AND ADVANTAGES

Accordingly the objects and advantages of the Electron Avalanche Drive Circuit described in the patent are;

(a) To provide a means of employing electron avalanche as developed in a high voltage spark gap exposed to open air for the delivery of increased current to the inductive load.
(b) To provide a power drive circuit capable of utilizing the additional current generated by the process of electron avalanche.
(c) To provide a means of releasing to ground the additional current generated by electron avalanche thus preventing damage to electric circuit components from current transients.

### SUMMARY

In accordance with the present invention, an Electron Avalanche Drive Circuit is comprised of a battery, battery bank or other low voltage power supply, an inverter, a high voltage transformer, a full wave bridge, a diode or diode bank, commutation, a high voltage spark gap exposed to open air or other suitable gaseous medium, an inductive load, a step-down transformer, a high speed, unidirectional, switching circuit and grounding.

The Electron Avalanche Drive Circuit employs electron avalanche as developed in a high voltage spark gap exposed to open air for the production of additional current above the initial current necessary to produce the arc. The additional current generated by electron avalanche enters the main circuit at the spark gap anode. The initial and additional current are employed to power an inductive load. The additional current developed by electron avalanche is then released to ground from the main circuit by means of a high speed, unidirectional switch.

### DRAWINGS

### Figures

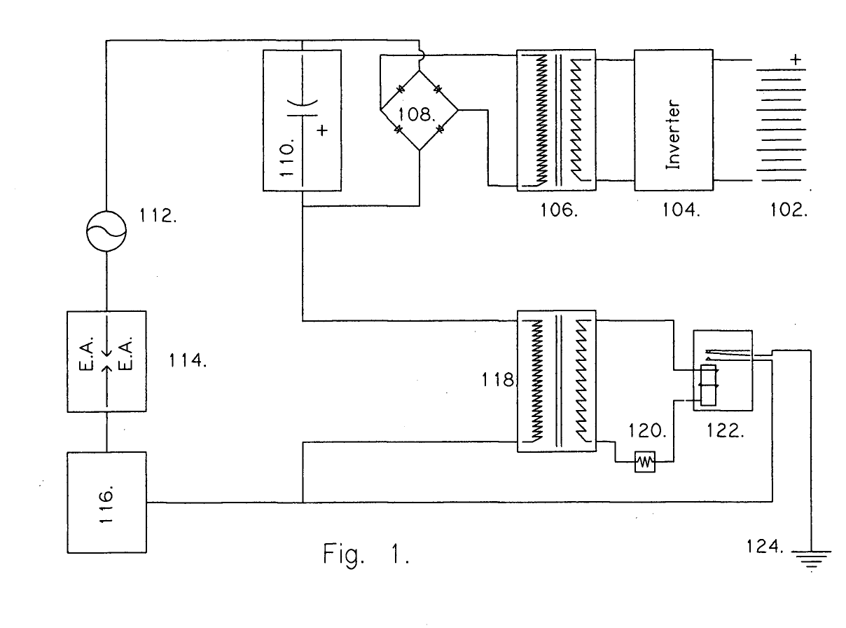

FIG. 1 shows the components of an Electron Avalanche Drive Circuit.

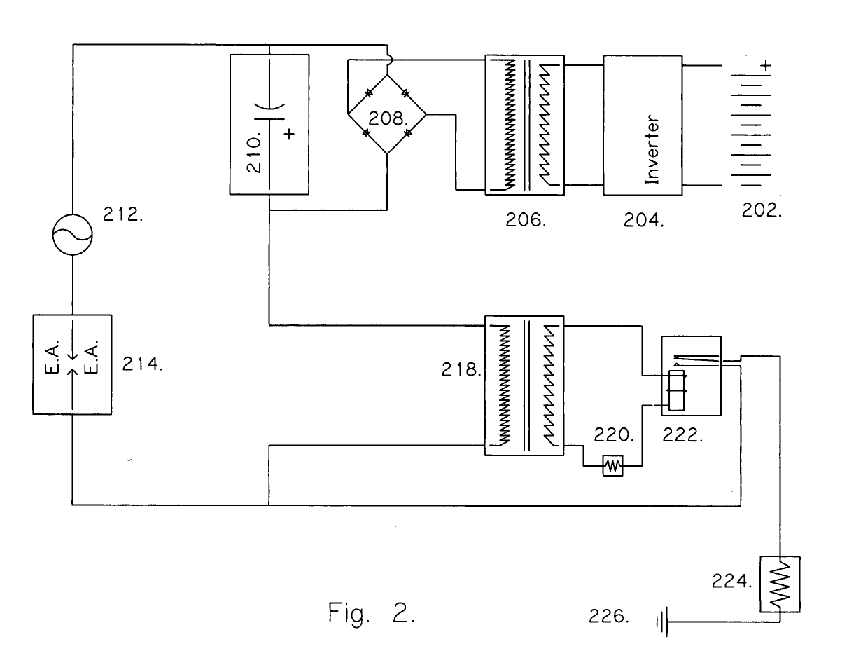

FIG. 2 shows the components of an Electron Avalanche Drive Circuit with a resistive type heating element load.

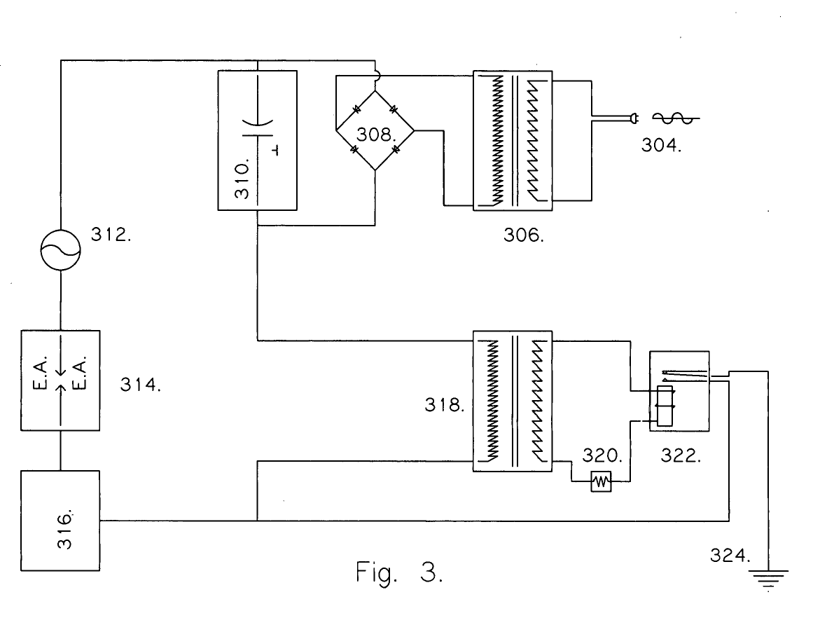

FIG. 3 shows the components of an Electron Avalanche Drive Circuit that employs standard residential electric power as an initial power source.

### DRAWINGS

### Reference Numerals

FIG. 1—Electron Avalanche Drive Circuit with inductive load.

| | | | |
|---|---|---|---|
| 102 | battery or battery bank | 104 | inverter |
| 106 | high voltage transformer | 108 | full wave bridge |
| 110 | capacitor or capacitor bank | 112 | commutation |
| 114 | spark gap | 116 | inductive load |
| 118 | step-down transformer | 120 | resistor |
| 122 | high speed, unidirectional switch | 124 | ground rod |

FIG. 2—Electron Avalanche Drive Circuit with a resitive heating element load.

| | | | |
|---|---|---|---|
| 202 | battery or battery bank | 204 | inverter |
| 206 | high voltage transformer | 208 | full wave bridge |
| 210 | capacitor or capacitor | 212 | commutation |
| | bank | | |
| 214 | spark gap | 218 | step down tranformer |
| 220 | resistor | 222 | high speed, unidirectional switch |
| 224 | resistive heating element | 226 | ground rod |

FIG. 3—Electron Avalanche Drive Circuit for residential power.

| | | | |
|---|---|---|---|
| 304 | plug | 306 | high voltage transformer |
| 308 | full wave bridge | 310 | capacitor or capacitor bank |
| 312 | commutaion | 314 | spark gap |
| 316 | load | 318 | step down transformer |
| 320 | resistor | 322 | high speed, unidirectional switch |
| 324 | ground rod | | |

### DETAILED DESCRIPTION

### FIG. 1—Preferred Embodiment

The preferred embodiment of an Electron Avalanche Drive Circuit is illustrated in FIG. 1. The Electron Avalanche Drive Circuit has a battery, battery bank or other low voltage power supply 102. The battery 102 powers an inverter 104 which utilizes the low voltage, direct current power input to produce a medium voltage, alternating current output. The output of the inverter 104 is connected to the primary of a high voltage transformer 106. The high voltage transformer 106 secondary produces a high voltage, alternating current output.

The high voltage, alternating current output of the high voltage transformer 106 is then rectified to a high voltage, direct current by means of a full wave bridge 108. The high voltage, direct current output of the full wave bridge 108 is then stored in a capacitor or capacitor bank 110.

The current stored in the capacitor 110 is then pulsed for the correct duration at the appropriate time by means of a commutator 112.

The pulse of current from the commutator 112 is then supplied to the cathode of the high voltage spark gap 114 exposed to open air or other suitable gaseous medium. The high voltage spark gap 114 width is determined by the breakdown potential of air and the working voltage of the main circuit. The initial current pulse is then multiplied by means of electron avalanche to produce additional current which enters the main circuit at the high voltage spark gap 114 anode.

The initial current from the capacitor 110 and the additional current produced by electron avalanche in the high voltage spark gap 114 is then delivered to an inductive load 116.

The initial current is then directed back to the positive potential of the capacitor 110 through the primary windings of a step-down transformer 118.

The additional current produced by electron avalanche is then routed to ground 124 by means of a high speed, unidirectional switching system 122. The high speed, unidirectional switch is controlled by the secondary power of the step-down transformer 118. The current necessary for the activation of the high speed, unidirectional switch 122 is regulated by a resistor 120.

The additonal current generated by electron avalanche is then directed to a ground rod 124.

### Operation

### FIG. 1.—Preferred Embodiment

The manner of operation for the Electron Avalanche Drive Circuit as illustrated by FIG. 1. is herein described. A battery, battery bank, or other low voltage power supply 102 supplies direct current to an inverter 104. The inverter 104 converts the direct current to alternating current. The low voltage, alternating current is then stepped-up to a medium voltage, alternating current by means of a step-up transformer internal to the inverter 104.

The medium voltage, alternating current ouput of the inverter 104 is then supplied to the primary of a high voltage, step-up transformer 106. The alternating current supplied to the primary of the high voltage transformer 106 induces a high voltage, alternating current output from the secondary.

The high voltage, alternating current output from the secondary of the high voltage transformer 106 is then rectified to direct current by a full wave bridge 108. The full wave bridge 108 is comprised of four diodes that provide a one way path for the current thus converting alternating current to direct current.

The high voltage, direct current output of the full wave bridge is then stored in a capacitor or capacitor bank 110. The direct current from the capacitor 110 provides the initial current necessary for the initiation of electron avalanche in the high voltage spark gap 114 exposed to open air or other suitable gaseous medium.

The direct current from the capacitor 110 is conditioned by a commutator 112 to provide a pulse of direct current for the proper duration at the proper time for the load 116. The commutation 112 may be mechanical or electronic.

The initial current pulse from the commutator 112 is then supplied to a cathode of the high voltage spark gap 114 exposed to open air. The initial current pulse initiates electron avalanche in the spark gap exposed to open air resulting in the multiplication of electrons as a result of the electrochemical process. The multiplication of electrons creates additional current which is absorbed by the anode of the spark gap 114.

The initial current and the additional current generated by electron avalanche are then delivered to the inductive load. 116.

The initial current is then directed through the primary of a step-down transformer 118 to the positive potential of the capacitor 110. The initial current pulse delivered to the primary of the step-down transformer 118 induces a medium voltage, current pulse in the secondary. The secondary of the step-down transformer provides the power necessary to activate and control a high speed, unidirectional switch 122. The current necessary for the proper functioning of the high speed, unidirectional switch is limited by a resistor 120. The high speed, unidirectional switch can be selected from high speed relays, diodes and silicon controlled rectifiers.

The additional current produced by electron avalanche is then directed to ground 124. The ground rod 124 acts as a sink for the excess current thus preventing cumulative current transients from damaging the main circuit components.

### Description

### FIG. 2—Additional Embodiment

While the above description of the preferred embodiment contains many specifications, these should not be construed as limitations on the scope of the invention, but rather as an exemplification of one preferred embodiment thereof. Many other variations are possible. For example, the additional current generated by electron avalanche may be employed to power a resistive type heating element as illustrated in FIG. 2.

As illustrated in FIG. 2 a low voltage power supply such as a battery or battery bank 202 supplies power to an inverter 204.

The inverter 204 supplies a medium voltage, alternating current to the primary of a high voltage transformer 206. The output of the secondary of the high voltage transformer 206 is a high voltage, alternating current.

The output of the high voltage transformer 206 is then rectified to a high voltage, direct current by a full wave bridge 208.

The high voltage, direct current output of the full wave bridge is then stored in a capacitor or capacitor bank 210.

The current stored in the capacitor 210 provides the initial current necessary for the initiation of electron avalanche in the high voltage spark gap 214 exposed to open air or other suitable gaseous medium.

The initial current supplied by the capacitor 210 is conditioned by commutation 212 to form a direct current pulse for the proper duration at the correct time as determined by the duty cycle. The initial current pulse from the commutator 212 is then delivered to the cathode of the high voltage spark gap 214 exposed to open air.

The initial current from the cathode initiates electron avalanche in a high voltage spark gap 214 exposed to open air. The electrochemical process of electron avalanche results in the multiplication of electrons which are absorbed by the anode of the spark gap 214 to form additional current in the main circuit.

The initial current is then directed through the primary of a step-down transformer 218 to the positive potential of the capacitor 210. The initial current pulse directed through the primary of the step-down transformer 218 induces a medium voltage current pulse in the secondary of the step-down transformer. The medium voltage current pulse of the secondary provides the power necessary to operate a high speed, unidirectional switch 222.

The current necessary to control the high speed, unidirectional switch is regulated by a resistor 220.

The additional current generated by electron avalanche is then released to ground 226 by the high speed unidirectional switch 222 through a resistive type heating element 224.

The successive pulses of additional current directed through the resisitive type heating element 224 provides the generation of radiant heat.

### Operation

### FIG. 2—Additional Embodiment

The operation of the Electron Avalanche Drive Circuit to provide power to a resistive type heating element illustrated in FIG. 2 is described as follows. A battery, battery bank or other low voltage, direct current power supply 202 provides power to an inverter 204.

The inverter 204 converts the low voltage, direct current input to an alternating current. The low voltage, alternating current is then stepped up to a mediun voltage, alternating current by a step-up transformer internal to the inverter 204.

The medium voltage, alternating current output of the inverter 204 is then supplied to a high voltage, step-up transformer 206 primary. The medium voltage, alternating current of the primary induces a high voltage, alternating current output in the secondary of the high voltage transformer 206.

The high voltage, alternating current output of the high voltage transformer 206 is then rectified to direct current by a full wave bridge 208. The full wave bridge rectifies the alternating current to direct current through four diodes configued to provide a one way path for the current.

The high voltage, direct current output of the full wave bridge 208 is then stored in a capacitor or capacitor bank 210.

The current stored in the capacitor 210 is then conditioned by commutation 212 to form a direct current pulse of the proper duration at the appropriate time. The commutator 212 may be a mechanical or electronic switching device.

The current pulse from the commutator 212 is then delivered to the cathode of a high voltage spark gap 214 exposed to open air or other suitable gaseous medium. The current pulse from the cathode initiates electron avalanche in the spark gap 214 exposed to open air. The electrochemical process of electron avalanche generates additional current by the ionization of air molecules resulting in the multiplication of electrons.

The initial current is then routed through the primary of a step-down transformer 218 to the positive potential of the capacitor 210. The initial high voltage current pulse through the primary of the step-down transformer 218 induces a medium voltage current pulse in the secondary. The secondary provides the power to control a high speed, unidirectional switching device 222.

The current in the control circuit of the high speed, unidirectional switching device 222 is regulated by a resistor 220.

The additional current generated by electron avalanche is routed through the high speed, unidirectional switching device to a resistive type heating element 224. The high speed, unidirectional switching device 224 can be but is not limited to high speed relays, diodes and silicon controlled rectifiers.

The additional current generated by electron avalanche, routed through the resistive type heating element, is then delivered to a ground rod 226.

### Description

### FIG. 3—Alternative Embodiment

While the description of the preferred embodiment contains many specifications, these should not be construed as limitations, but rather as exemplifications of one preferred embodiment thereof. Many other variations are possible. For example, typical residential electric power of 115 volts or 230 volts alternating current may be utilized to power the circuit rather than a battery with an inverter as illustrated in FIG. 3.

Shown in FIG. 3 is a typical plug 304 for residential 115 volt or 230 volt alternating current. The residential electric power 304 is supplied to the primary of a high voltage, step-up transformer 306.

The secondary output of the high voltage transformer 306 provides a high voltage alternating current to a full wave bridge. 308. The output of the full wave bridge is a high voltage direct current. The high voltage direct current is then stored in a capacitor or capacitor bank 310.

The current stored in the capacitor 310 provides the initial current pulse necessary to produce electron avalanche in a high voltage spark gap 314 exposed to open air. The initital current pulse is conditioned to the correct duration at the appropriate time by commutation 312.

The initial current pulse provided by the commutator 312 is then delivered to the cathode of the high voltage spark gap 314 exposed to open air. The initial current pulse initiates electron avalanche in the open air of the high voltage spark gap 314. The electrochemical process of electron avalanche results in the multiplication of electrons which are absorbed by the anode of the high voltage spark gap 314.

The initial current and the additional current generated by electron avalanche are then delived to an inductive load 316.

The initial current from the inductive load is then routed through the primary of a step-down transformer 318 to the positive potential of the capacitor 310.

The initial current through the primary of the step-down transformer 318 induces a current pulse in the secondary of the transformer 318. The secondary provides the power for the control of a high speed, unidirectional switch 322. The current in the control circuit is limited by a resistor 320.

The additional current generated by electron avalanche is then routed through the high speed, unidirectional switch 322 to a ground rod 324.

### Operation

### FIG. 3—Alternative Embodiment

The operation of the invention's alternative embodiment as illustrated in FIG. 3 is described below. A typical plug 304 connected to a residential 115 volt or 230 volt, alternating current, electric power outlet provides the power necessary for the primary of a high voltage, step-up transformer 306.

The alternating current applied to the primary of the high-voltage, step-up transformer 306 induces a high voltage, alternating current in the secondary.

The high voltage, alternating current output of the high-voltage transformer's 306 secondary is then rectified to direct current by a full wave bridge 308. The full wave bridge 308 employes four diodes to construct a one-way path for the alternating current to become direct current.

The direct current output of the full wave bridge 308 is then stored in a capacitor or capacitor bank 310. The initial current stored in the capacitor is the current necessary to initiate electron avalanche in the high voltage spark gap exposed to open air 314.

The initial current is conditioned to form a direct current pulse for the proper duration delivered at the appropriate time by commutation 312. The commutator 312 may be mechanical or electronic. The initial current pulse is then delivered to the cathode of the high voltage spark gap 314 exposed to open air or other suitable gaseous medium.

The initial current delivered to the cathode of the spark gap 314 initiates the electrochemical process of electron avalanche in the open air between the cathode and the anode. The process of electron avalanche generates multiple electrons to form additional current in the main circuit delivered to the load 316. The additional current generated by electron avalanche is absorbed by the anode of the spark gap 314.

The initital current and the additional current are then delivered to the inductive load 316 increasing the magnetic flux generated by the inductor.

The initial current is then routed through the primary of a step-down transformer 318 to the positive potential of the capacitor 310. The initial current pulse through the primary of the step-down transformer 318 induces a medium voltage, current pulse in the secondary of the transformer 318.

The secondary of the step-down transformer 318 provides the power necessary for the control of a high speed, unidirectional switch 322. The current necessary for the proper activation of the high speed switch control circuit is regulated by a resistor 320.

The additional current generated by electron avalanche is then routed to a ground rod 324 through the high speed, unidirectional switch 322 when the control circuit is closed. The high speed, unidirectional switch may be, but is not limited to, high speed relays, diodes, and silicon controlled rectifiers.

### CONCLUSION, RAMIFICATIONS AND SCOPE

1) Provides clean renewable energy.
2) Reduces the United States of America dependence on imported oil.
3) Provides a backup power supply for Federal, State, Local Government and the Military.
4) Affordable heating.
5) Reduces CO2 emissions.
6) Reduces air pollution
7) Increases available electric power in the United States of America.

I claim:

1. An electron avalanche drive circuit with a high voltage spark gap exposed to air or other suitable gaseous medium where the electrochemical process of electron avalanche generates additional current delivered to an inductive load.

2. The circuit of claim 1 wherein is composed of a battery, battery bank or other low voltage, direct current power supply which provides power to an inverter.

3. The circuit of claim 1 wherein is composed of an inverter which converts direct current to alternating current.

4. The circuit of claim 1 wherein is composed of a high voltage, step-up transformer which produces a high voltage, alternating current output.
The circuit of claim 1 wherein is composed of a full wave bridge which rectifies the alternating current to direct current.
The circuit of claim 1 wherein is composed of a capacitor or capacitor bank which stores the high voltage, direct current.
The circuit of claim 1 wherein is composed of a commutator which conditions the initial current to a current pulse of the proper duration at the correct time.
The circuit of claim 1 wherein is composed of a high voltage spark gap exposed to open air. Within the high voltage spark gap exposed to open air the electrochemical process of electron avalanche generates additional current that is delivered to an inductive load.
The circuit of claim 1 wherein is composed of a step-down, transformer which provides the power necessary to activate a high speed, unidirectional switch.
The circuit of claim 1 wherein is composed of a control circuit which employes a resistor to limit the current.
The circuit of claim 1 wherein is composed of a high speed, unidirectional switch which is selected from the group of switching elements composed of high speed relays, diodes and silicon controlled rectifiers. The high speed, unidirectional switch allows the additional current generated by electron avalanche to leave the main circuit and go to ground.
The circuit of claim 1 wherein is composed of a ground rod which allows the additional current to sink to ground.
Whereby the generation of additional current by the process of electron avalanche in a high voltage spark gap exposed to open air is delivered to an inductive load.

2. An electron avalanche drive circuit with a high speed, unidirectional switch that releases to ground the additional current generated by electron avalanche in a high voltage spark gap exposed to open air.
The circuit of claim 2 wherein is composed of a step-down transformer which supplies the power necessary to control the high speed, unidirectional switch.
The circuit of claim 2 wherein is composed of a resistor which limits the current to the high speed, unidirectional switch.
The circuit of claim 2 wherein is composed of a high speed, unidirectional switch which may be selected from the group of switching elements including high speed relays, diodes and silicon controlled rectifiers.
The circuit of claim 2 wherein is composed of a ground rod which allows the additional current generated by electron avalanche to go to ground.
Whereby the generation of additional current produced by electron avalanche in a high voltage spark gap exposed to open air is released from the main circuit to ground.
